(19) United States
(12) Patent Application Publication
(10) Pub. No.: US 2024/0375215 A1
(43) Pub. Date: Nov. 14, 2024

(54) Method for Laser Welding of Steel Plates

(71) Applicant: ANDRITZ Soutec AG, Neftenbach (CH)

(72) Inventors: Hanspeter Meyer, Hüttwilen (CH); Jean-Frédéric Clerc, Bülach (CH)

(21) Appl. No.: 18/689,209

(22) PCT Filed: Jul. 29, 2022
(86) PCT No.: PCT/EP2022/071320

§ 371 Date: Mar. 5, 2024

(30) Foreign Application Priority Data
Sep. 27, 2021 (AT) A 50761/2021

(51) Int. Cl. B23K 26/08; B23K 26/064; B23K 26/26; B65G 17/08; B65G 17/32; F28F 3/00; H01M 8/0202

(52) U.S. Cl. CPC B23K 26/0838; B23K 26/064; B23K 26/26; B65G 17/086; B65G 17/323; H01M 8/0202; F28F 3/00; F28F 2275/067; H01M 2250/20

(57) ABSTRACT

A device and method that allows bipolar plates to be welded in a rotating transport device in a vertical position at high speed, thereby fulfilling the high requirements for loading, fixing, welding and unloading the components to a high degree. Overall, a high level of productivity is achieved with the device and method.

### BACKGROUND

The disclosed embodiments relate to a method for laser welding of flat steel plates, particular bipolar plates for fuel cells, in commercial vehicle manufacturing, or heat exchanger plates. They further relate to an application of the method for the production of bipolar plates or heat exchanger plates.

In the automotive industry, the trend is increasingly moving in the direction of reducing CO₂ and using alternative drive systems as a result of finite oil reserves and the climate change. Cars and trucks are increasingly using electric motors with batteries as storage medium. However, other technologies such as fuel cells will also become established in the future, particularly in the truck sector. Bipolar plates (BPP) are main components of a fuel cell and therefore have a decisive influence on the manufacturing costs and efficiency of a fuel cell system. Due to several advantages in terms of manufacturability and material properties such as stability, low sheet thickness and a wide range of coating options, the metallic versions of bipolar plates are becoming the focus of research and development and are currently considered the preferred variant for future large-scale applications of fuel cells. A fuel cell system consists of a large number of individual cells, each with a BPP between the cells, for automotive applications typically with 300-400 bipolar plates. Due to the high number of BPPs per individual system, it can be assumed that the quantities required will quickly reach very large dimensions in the future, even under moderate scenarios. This challenge can also be seen as an enormous opportunity for BPP suppliers. However, this requires economical and high-performance production technology. In particular, the welding of the two bipolar plate halves to form a BPP is a key problem due to the large number of weld seams, the associated long welding times and the high demands on the weld seams combined with very difficult process conditions due to the thin materials. At present, this is still a significant obstacle to cost-efficient production.

BPPs as such are known from the state of the art. They usually consist of two bipolar plate halves that are joined together. These are usually embossed foils or formed sheets. The bipolar plate halves lie on top of each other and are usually laser-welded tightly around the edges and at the contact points. The laser produces several metres of weld seam and possibly additional spot welds. Resistance welding methods are also a known alternative. Here, welding devices are used, which often require the bipolar plate halves to be clamped several times in order to produce a seal contour and all the welding points. In order to be able to weld all sealing contours and points, the bipolar plate to be welded must be removed from the clamping device and re-inserted so that all areas of the BPP to be welded are accessible to the welding laser. In particular, circumferential sealing contours cause problems. If such surrounding sealing contours are produced with the laser in a single welding process, It may prove difficult to place additional clamping elements within the sealing contour to fix the bipolar plate halves within the surrounding welding contour. When re-clamping, there is a risk that the positioning will no longer match and welding points will be set in the wrong places. In addition, the entire bipolar plate production process can be significantly delayed by re-clamping the half-finished bipolar plate.

The patent specification DE102016200387 describes a device and a method for producing a bipolar plate in which the distortion of the component is comparatively low. Welding energy is applied to the BPP from above and below. The position in the room where this is done is not described.

WO2018149959 shows a clamping device with clamping levers. From the image and text it can be concluded that the orientation of the BPP is horizontal, i.e. the surface lies horizontally on a base.

GRÄBENER Maschinentechnik shows a complete production line for BPP on its homepage. Two welding systems are also shown in detail at https://www.graebener.com/en/cutting-and-welding. BPP are welded horizontally at standstill.

The company SITEC (HTTPS://WWW.SITEC-TECHNOLOGY.DE/) manufactures automated laser welding plants, whereby welding is also carried out during standstill and in a horizontal plane.

European patent specification EP3038789 describes a method for increasing cycle times and thus reducing production costs in the industrial production of welded sheet metal parts—in particular, tailored blanks for the automotive industry. The method is based on a transport system with flying optics and horizontal alignment of the workpiece during welding, and does not require any complex cooling of the hot weld seam or any means of holding the workpieces with high force on one side of the conveyor belt. This can greatly reduce the negative impact of the gap between blanks on the machine's cycle time. Overall, the method can reduce non-productive welding time.

However, in such a system with vertical movement, the return path cannot be used for manipulation unless access is gained from the underside of the machine.

US 6,639, 176 B1 describes a welding device in which metal sheets are welded together vertically to minimize the space required for the welding device.

The disadvantages of the aforementioned solutions are the high technical effort required to reliably clamp the components, for the removal of welding fumes and spatter from the system, large machine dimensions with high investment costs, and the overall low productivity of the entire system.

### SUMMARY

The inventive embodiments are thus based on the task of describing a method by which the above-mentioned disadvantages are eliminated.

The device for the method described here is based on a transport device that transports the workpieces to be welded in the horizontal plane, which greatly reduces the number of system parts required.

As the circulating conveyor belt moves in a horizontal plane, access is possible from both sides. This means that the steel plates (workpieces) are welded on one side and the steel plates are loaded and unloaded on the other side.

Respectively in between, the steel plates are fixed in place with clamping plates or the fixing is released again.

This generates the following advantages:
Reduction in investment costs due to a smaller number of welding devices
Reduction of investment costs by minimising machine dimensions (footprint, component sizes, etc.)
Reducing investment costs ultimately leads to lower production costs.

Another advantage is that the welding process takes place vertically, i.e. in perpendicular direction and approximately vertically to the transport direction. This means that welding spatter does not remain on the workpiece being processed, resulting in less contamination of the workpieces and the device.

In the disclosed preferred configuration, the workpiece is clamped only once and then welded, eliminating repeated clamping with the known problems of precise adjustment during welding of the workpiece and achieving a high level of overall accuracy during loading, welding, and unloading.

The embodiments significantly increase the number of produced parts per time unit while simultaneously reducing part costs.

Hence, the disclosure enables efficient and high-quality production overall.

### BRIEF DESCRIPTION OF THE DRAWINGS

The present invention is further explained in the following on the basis of example embodiments and referring to drawings. In the drawings,

FIG. 1 is a schematic top view of an embodiment of the transport device,

FIG. 2A is a first perspective view of a clamping device,

FIG. 2B is a second perspective view of a clamping device,

FIG. 2C is a third perspective view of a clamping device,

FIG. 2D a fourth perspective view of a clamping device, and

FIG. 3 is a schematic side view of the plant according to the invention.

### DETAILED DESCRIPTION

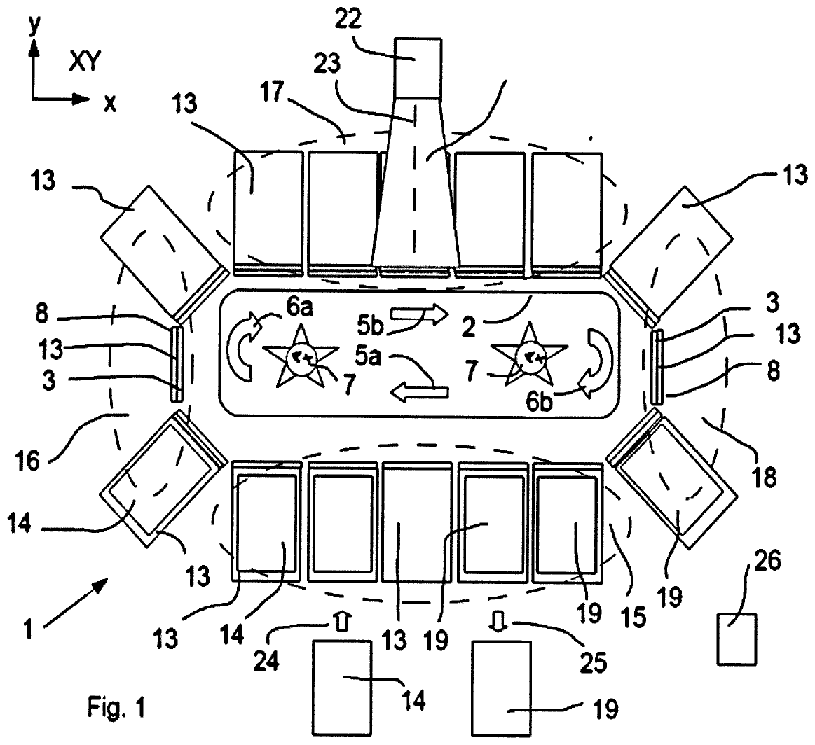

FIG. 1 shows a top view of a rotating transport device 1 whose drive 7 moves the conveyor belt 2 clockwise in the transport plane XY, travelling through areas of translatory movement 5a,5b and rotary movement areas 6a,6b. The transport plane XY is essentially the horizontal plane. The conveyor belt 2 consists of a large number of conveyor links 3, which are equipped with a clamping device 8. A base plate 11 and a swivelling folding lever 13 are attached to each chain link 3. The workpiece 14 to be welded can be held between the base plate 11 and the folding lever 13. Loading 24 of the circulating conveyor belt 2 with the workpieces, i.e. with the steel plates, takes place in the translatory area 5a with the folding lever 13 folded out and horizontal in the loading/unloading zone 15. In the welding device loading zone 16 in the area of rotative movement 6a, the workpiece 14 is brought into a vertical position in the clamping device 8 by folding back (folding up) the folding lever 13 and fixed to the base plate 11 by means of clamping means (clamping plates B 10b and A 10a). In the next step, the folding lever 13 is brought back into the horizontal position. This is necessary so that the laser beam 23 of the welding laser 22 can be directed onto the workpiece 14 in the subsequent step. In the translatory area 5b, the workpiece 14 is welded in the welding/cutting zone 17 by means of the laser beam 23 of the laser optics 22. Here, the two steel plates of the workpiece 14 are welded together. It is also conceivable that the laser beam 23 could also be used for cutting or marking. In the unloading zone 18 of the welding device, the folding lever 13 is folded in a first step into a vertical position and the clamping device 8 with the now welded workpiece 19 is folded in a second step from a vertical into a horizontal position. In the loading/unloading zone 15, the welded workpiece 19 is removed from the circulating conveyor belt 2 by unloading 25. The cleaning station 26 is used to clean the clamping device 8.

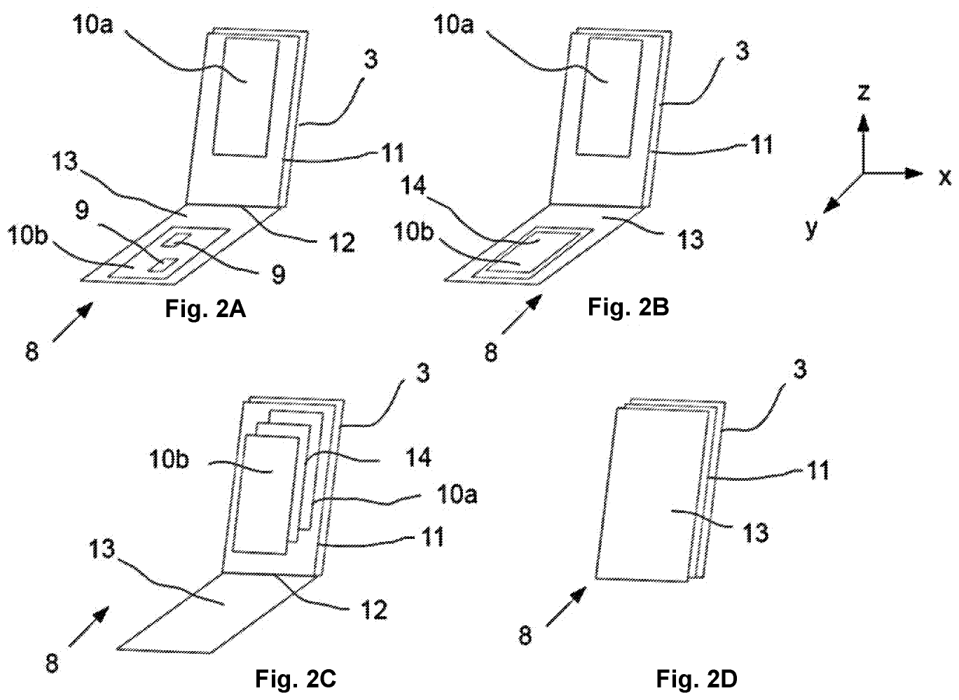

FIG. 2A shows a first perspective view of the clamping device 8 in the state before loading, without the workpiece 14 to be welded. A clamping plate A 10a is attached, preferably fixed, to the base plate 11, which is firmly connected to the chain link 3. The clamping plate B 10b, possibly with several partial clamping plates 9, is detachably fixed on the folding lever 13. The clamping plate B 10b can be fixed and released on the folding lever 13 by magnetic force or mechanically. The folding lever 13 is located in a horizontal position in the XY plane and is connected to the clamping device 8 so that it can rotate around the swivelling axis 12.

FIG. 2B shows a second perspective view of the clamping device 8 in the “loaded” state, whereby the workpiece 14 to be welded is positioned and fixed relative to the clamping plate B 10b. The workpiece 14 is therefore placed on the clamping plate B 10b. The folding lever 13 is in a horizontal position in the XY plane.

FIG. 2C shows a third perspective view of the clamping device 8, in “welded” state. The workpiece 14 to be welded is fixed between the two plates clamping plate A 10a and clamping plate B 10b. The clamping plate B 10b is no longer present on the folding lever 13. The folding lever 13 is in a horizontal position in the XY plane. The workpiece 14, i.e. the two steel plates to be welded, are clamped between the two clamping plates A 10a and B 10b. Clamping can preferably be done using magnetic forces. The clamping plates A 10a and B 10b are designed in such a way that they sufficiently press the steel plates to be welded together over their entire surface, whereby the areas in which the laser beam 23 hits the workpiece 14 are excluded in the clamping plate B 10b.

FIG. 2D shows a fourth perspective view of the clamping device 8, in “closed” state. The folding lever 13 is folded out of the XY plane into the XZ plane, now rests on the base plate 11 and is in a vertical position. This state is assumed when the workpiece 14 is placed on the clamping plate A 10a and also when the workpiece 14 is lifted off the clamping plate A 10a.

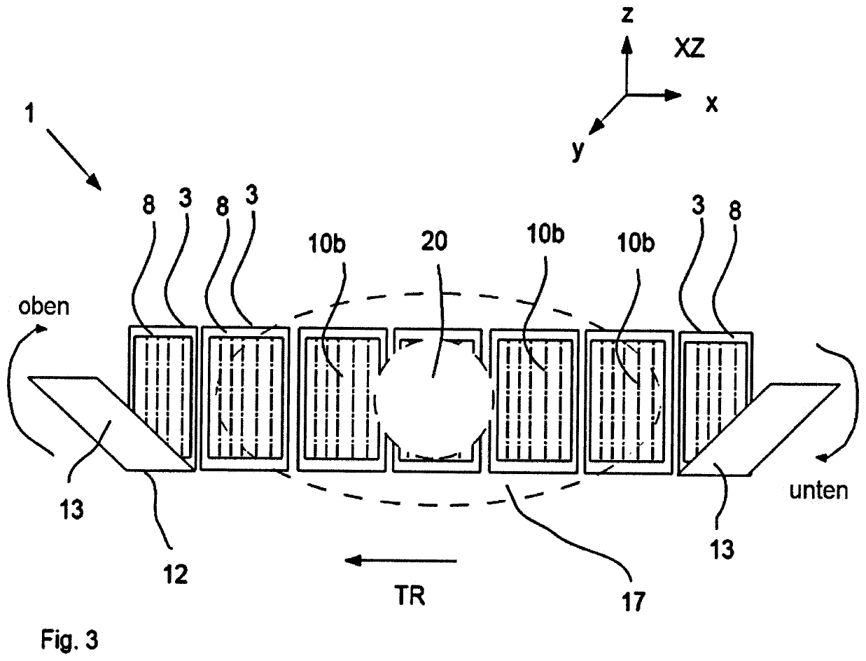

FIG. 3 shows a side view of the welding/cutting area 17 of the circulating transportation device 1, whose chain links 3 move continuously in the plane XY in transport direction TR. The clamping device 8 is in the “welding” state. The workpiece to be welded 14 is fixed in the clamping device 8 between the clamping plate A 10a and the clamping plate B 10b. At welding plane XZ, the laser optics cover the entire working area 20. The folding levers 13 are in the “Folding down” DOWN or “Folding up” UP status. The folding lever 13 is folded down during welding.

The disclosed method for laser welding of workpieces 14 can proceed as follows:

In the loading zone 15, the folded-down folding lever 13 of the clamping device 8 is loaded with at least one workpiece 14 to be machined and the workpiece is fixed on the clamping plate B 10b, for example with the aid of magnetic forces. Thereby, the clamping plate B 10b rests on the folding lever 13. In the loading zone 16 of the welding device, the folding lever 13 is now turned about the swivelling axis 12 by approximately 90 degrees from the approximately horizontal to an approximately vertical position and the workpiece 14 to be welded and the clamping plate B 10b are fixed to the base plate 11 and to a clamping plate A (10a) which is attached to the base plate 11.

After this, the folding lever (13) without the clamping plate B 10b and the workpiece 14 is turned back by approximately 90 degrees from the vertical to an approximately horizontal position.

In the welding/cutting zone 17, the workpiece 14, which is clamped between the clamping plate A 10a and the clamping plate B 10b, is then welded by a welding laser. Then, in the unloading zone 18 of the welding device, the folding lever 13 is turned again about the swivelling axis 12 by approximately 90 degrees from the approximately horizontal to an approximately vertical position and then takes on the welded workpiece 19 and the clamping plate B 10b. The folding lever 13 with the welded workpiece 19 and the clamping plate B 10b is turned back from an approximately vertical position by 90 degrees to an approximately horizontal position.

The workpiece 14 and the clamping plate B 10b can be transferred and fixed in place using magnetic forces.

In the unloading zone 15, the welded workpiece 19 is then removed from the clamping plate B 10b and moved on to subsequent steps. The clamping plate B 10b always remains in the device.

### REFERENCE NUMERALS

1 Transport device
2 Conveyor belt
3 Chain link
5a,b Area of translatory movement
6a,b Area of rotative movement
7 Drive
8 Clamping device
9 Partial clamping plates
10a Clamping plate A
10b Clamping plate B
11 Base plate
12 Swivelling axis
13 Folding lever
14 Workpiece to be machined
15 Loading/unloading zone
16 Welding device—loading zone
17 Welding/cutting zone
18 Welding device—unloading zone
19 Machined workpiece/welded workpiece
20 Work area
22 Laser optics
23 Laser beam
24 Loading
25 Unloading
26 Cleaning station
TR Transport direction
XY Transport plane
XZ Welding plane

1-12. (canceled)

13. A method for laser welding workpieces (14) with a device using a transport device (1) rotating in a transport plane XY, the transport device (1) comprising a chain-like conveyor belt (2) with chain links (3), each chain link (3) provided with a clamping device (8) having a base plate (11) and a folding lever (13), the workpiece (14) being fixed to the base plate (11) via clamping plates (10a, 10b) for the welding process, the device having at least one laser optical system (22) for welding the workpiece (14), the transport plane XY lying in a horizontal plane and the welding process taking place in a welding plane XZ, comprising:
loading the clamping device (8) with at least one workpiece (14) to be welded and fixing the workpiece (14) to be welded on a clamping plate B (10b) in a loading zone (15);
rotating the folding lever (13) about a swivelling axis (12) by approximately 90 degrees from an approximately horizontal position to an approximately vertical position, and fixing the workpiece (14) to be welded and the clamping plate B (10b) to the base plate (11) and a clamping plate A (10a) in a welding device/loading zone (16);
turning back the folding lever (13) of the clamping device (8) by approximately 90 degrees from the approximately vertical position to the approximately horizontal position in the welding device-loading zone (16);
welding the workpiece (14) that is fixed between the clamping plate A (10a) and the clamping plate B (10b) in a welding/cutting zone (17);
rotating the folding lever (13) about the swivelling axis (12) by approximately 90 degrees from an approximately horizontal position to an approximately vertical position and taking over the welded workpiece (19) and the clamping plate-B (10b) in a welding device/unloading zone (18);
turning back the folding lever (13) with the welded workpiece (19) and the clamping plate-B (10b) from an approximately vertical position by 90 degrees to an approximately horizontal position in the welding device/unloading zone (18); and
removing the welded workpiece (19) from the clamping plate-B (10b) in the unloading zone (15).

14. The method according to claim 13, wherein the circulating transport device (1) follows an oval-shaped path in the transport plane XY and is divided into two linear movement regions (5a, 5b) and two rotary movement regions (6a, 6b).

15. The method according to claim 13, wherein the transport device (1) rotating in the transport plane XY moves linearly in the welding/cutting zone (17) and moves rotationally in the welding device/unloading zone (18), the welding device/loading zone (16) and the loading/unloading zone (15).

16. The method according to claim 14, wherein the transport device (1) rotating in the transport plane XY moves linearly in the welding/cutting zone (17) and moves rotationally in the welding device/unloading zone (18), the welding device/loading zone (16) and the loading/unloading zone (15).

17. The method according to claim 13, wherein the workpiece (14) to be welded is fixed perpendicular to the transport plane XY in the clamping device (8) on the circulating transport device (1) and is welded in the welding/cutting zone (17).

18. The method according to claim 14, wherein the workpiece (14) to be welded is fixed perpendicular to the transport plane XY in the clamping device (8) on the circulating transport device (1) and is welded in the welding/cutting zone (17).

19. The method according to claim 15, wherein the workpiece (14) to be welded is fixed perpendicular to the transport plane XY in the clamping device (8) on the circulating transport device (1) and is welded in the welding/cutting zone (17).

20. The method according to claim 13, wherein the laser source (23) provides coverage of an entire working area (20) with the at least one laser optic (22).

21. The method according to claim 14, wherein the laser source (23) provides coverage of an entire working area (20) with the at least one laser optic (22).

22. The method according to claim 15, wherein the laser source (23) provides coverage of an entire working area (20) with the at least one laser optic (22).

23. The method according to claim 17, wherein the laser source (23) provides coverage of an entire working area (20) with the at least one laser optic (22).

24. The method according to claim 13, wherein the workpiece (14) to be welded is loaded and unloaded in the loading/unloading zone (15) directly onto the clamping plate-A (10a).

25. The method according to claim 14, wherein the workpiece (14) to be welded is loaded and unloaded in the loading/unloading zone (15) directly onto the clamping plate-A (10a).

26. The method according to claim 15, wherein the workpiece (14) to be welded is loaded and unloaded in the loading/unloading zone (15) directly onto the clamping plate-A (10a).

27. The method according to claim 17, wherein the workpiece (14) to be welded is loaded and unloaded in the loading/unloading zone (15) directly onto the clamping plate-A (10a).

28. The method according to claim 20, wherein the workpiece (14) to be welded is loaded and unloaded in the loading/unloading zone (15) directly onto the clamping plate-A (10a).

29. The method according to claim 13, wherein the welded workpieces (14) are bipolar plates for fuel cells or for heat exchanger plates for transferring thermal energy.

30. The method according to claim 14, wherein the welded workpieces (14) are bipolar plates for fuel cells or for heat exchanger plates for transferring thermal energy.

31. The method according to claim 15, wherein the welded workpieces (14) are bipolar plates for fuel cells or for heat exchanger plates for transferring thermal energy.

32. The method according to claim 17, wherein the welded workpieces (14) are bipolar plates for fuel cells or for heat exchanger plates for transferring thermal energy.
